(19) United States
(12) Patent Application Publication
(10) Pub. No.: US 2023/0160304 A1
(43) Pub. Date: May 25, 2023

(54) METHOD AND SYSTEM FOR PREDICTING RELATIVE PERMEABILITY CURVE BASED ON MACHINE LEARNING

(71) Applicant: Institute of Geology and Geophysics, Chinese Academy of Sciences, Beijing (CN)

(72) Inventors: Shoudong Huo, Beijing (CN); Jiaru Zou, Beijing (CN); Enliang Liu, Beijing (CN); Xuhui Zhou, Beijing (CN); Shengqiang Mu, Beijing (CN); Liang Huang, Beijing (CN)

(21) Appl. No.: 17/988,990

(22) Filed: Nov. 17, 2022

(30) Foreign Application Priority Data
Nov. 19, 2021 (CN) 202111400726.0

(51) Int. Cl. E21B 49/02

(52) U.S. Cl. CPC E21B 49/025; E21B 2200/20

(57) ABSTRACT

The present disclosure provides a method and system for predicting a relative permeability curve based on machine learning. The present disclosure takes logging curve data as an input, and water saturation endpoint values as an output to establish a first relative permeability curve starting point model, and takes the logging curve data and a predicted water saturation starting value output from the first relative permeability curve starting point model as an input, and relative permeabilities under different water saturations as an output to establish a first relative permeability model, thereby obtaining a comprehensive prediction method for the relative permeability curve based on deep learning, and implying control mechanisms and parameters to a model.

### CROSS REFERENCE TO RELATED APPLICATION

This patent application claims the benefit and priority of Chinese Patent Application No. 202111400726.0, filed with the China National Intellectual Property Administration on Nov. 19, 2021, the disclosure of which is incorporated by reference herein in its entirety as part of the present application.

### TECHNICAL FIELD

The present disclosure relates to the technical field of data mining in oilfield development, and in particular to a method and system for predicting a relative permeability curve based on machine learning.

### BACKGROUND

The dynamic heterogeneity of reservoirs is significantly enhanced as the oilfield development enters a high water-cut stage. How to utilize various types of relevant static and dynamic data of the reservoirs to make comprehensive evaluation on the oilfield development, realize fine reservoir identification and provide an effective reservoir reconstruction scheme has become a main challenge in reservoir development.

An oil recovery factor can be improved by researching a seepage mechanism of fluid in oilfield exploitation. Representing seepage laws of oil and water phases in porous media, an oil-water relative permeability curve is mainly used for analyzing oil production capacities of wells and calculating an output of the oilfield. It provides essential references to evaluate a seepage intensity of the multi-phase fluid in reservoir rock, and is of importance to research seepage characteristics of polymer flooding. For water-flooding oilfields, the oil-water relative permeability curve is crucial to well stimulation and tertiary oil recovery of the reservoir stratum. The oil-water relative permeability curve plays an important role to explain a water-flooded layer of the adjustment well, and evaluate a remaining oil saturation (ROS) of the reservoir stratum with logging data. How to accurately acquire typical basic relative permeability data is challenging to oilfield workers.

The methods for obtaining a relative permeability are different under different conditions. Presently, a laboratory core test method is commonly used to determine the relative permeability curve of the reservoir stratum. However, the measurement of the relative permeability curve with a reservoir core in the laboratory is time-consuming and not cost-effective, and requires professional staffs and equipment, further causing insufficient samples to research the seepage relation in the oilfield development area, and restricting the modeling accuracy in reservoir exploitation.

In view of this, it is desirable to research and develop a method for predicting the relative permeability curve with the high accuracy and low cost (including time cost, human cost, financial cost, etc.).

### SUMMARY

An objective of the present disclosure is to provide a method and system for predicting a relative permeability curve based on machine learning, so as to improve the accuracy of prediction on the relative permeability curve, and reduce the cost and workload.

To achieve the above objective, the present disclosure provides the following technical solutions:

A method for predicting a relative permeability curve based on machine learning includes:

acquiring relative permeability curve data of a rock sample and logging curve data of a well where the rock sample is located, the relative permeability curve data including water saturations and relative permeabilities corresponding to different water saturations;

selecting a part of the relative permeability curve data and a part of the logging curve data as sample relative permeability curve data and sample logging curve data;

taking the sample logging curve data as an input and a water saturation starting value in the sample relative permeability curve data as a marker, and training a relative permeability curve starting point model with a machine learning algorithm to obtain a first relative permeability curve starting point model;

obtaining a predicted water saturation starting value according to the first relative permeability curve starting point model;

taking the sample logging curve data and the predicted water saturation starting value as an input, and a relative permeability in the sample relative permeability curve data as a marker, and training a relative permeability model with the machine learning algorithm to obtain a first relative permeability model;

obtaining a predicted relative permeability according to the first relative permeability model; and

plotting a relative permeability curve according to the predicted water saturation starting value and the predicted relative permeability corresponding to the predicted water saturation starting value.

A system for predicting a relative permeability curve based on machine learning includes:

a sample acquisition module configured to acquire relative permeability curve data of a rock sample and logging curve data of a well where the rock sample is located, the relative permeability curve data including water saturations and relative permeabilities corresponding to different water saturations;

a sample data selection module configured to select a part of the relative permeability curve data and a part of the logging curve data as sample relative permeability curve data and sample logging curve data;

a first relative permeability curve starting point model training module configured to take the sample logging curve data as an input and a water saturation starting value in the sample relative permeability curve data as a marker, and train a relative permeability curve starting point model with a machine learning algorithm to obtain a first relative permeability curve starting point model;

a water saturation starting value prediction module configured to obtain a predicted water saturation starting value according to the first relative permeability curve starting point model;

a first relative permeability model training module configured to take the sample logging curve data and the predicted water saturation starting value as an input, and a relative permeability in the sample relative permeability curve data as a marker, and train a relative permeability model with the machine learning algorithm to obtain a first relative permeability model;

a relative permeability prediction module configured to obtain a predicted relative permeability according to the first relative permeability model; and

a relative permeability curve plotting module configured to plot a relative permeability curve according to the predicted water saturation starting value and the predicted relative permeability corresponding to the predicted water saturation starting value.

According to the specific embodiments provided by the present disclosure, the present disclosure discloses the following technical effects:

The present disclosure provides the method and system for predicting a relative permeability curve based on machine learning. With an artificial intelligence (AI) algorithm as a tool, the present disclosure researches factors influencing accuracy of prediction on a relative permeability, and clarifies a relation between logging data and the relative permeability. The present disclosure takes logging curve data as an input, and water saturation endpoint values as an output to establish a first relative permeability curve starting point model, and takes the logging curve data and a predicted water saturation starting value output from the first relative permeability curve starting point model as an input, and relative permeabilities under different water saturations as an output to establish a first relative permeability model, thereby obtaining a comprehensive prediction method for the relative permeability curve based on deep learning, and implying control mechanisms and parameters to a model. Without establishing a mathematical relative permeability model and simulating a nonlinear control mechanism, the present disclosure improves the efficiency for obtaining the relative permeability curve, reduces the relative permeability curve prediction cost (including the time cost, human cost, financial cost, etc.), achieves the higher accuracy of prediction, provides the feasibility and technical support for application of the AI to inversion and imaging problems, and thus is taken as an effective tool to predict the relative permeability.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a flowchart of a method for predicting a relative permeability curve based on machine learning according to Embodiment 1 of the present disclosure;

FIG. 2 is a schematic view illustrating a part of logging data according to Embodiment 1 of the present disclosure;

FIG. 3 is a schematic view illustrating original logging data measured at an oilfield according to Embodiment 1 of the present disclosure;

FIG. 4A is a schematic view before consistency correction on a gamma-ray (GR) logging curve according to Embodiment 1 of the present disclosure;

FIG. 4B is a schematic view after consistency correction on a GR logging curve according to Embodiment 1 of the present disclosure;

FIG. 5 is a schematic view illustrating complementation of a GR logging curve according to Embodiment 1 of the present disclosure;

FIG. 6 is a schematic view illustrating a result of an oil relative permeability curve predicted with logging data according to Embodiment 1 of the present disclosure;

FIG. 7 is a schematic view illustrating a result of a water relative permeability curve predicted with logging data according to Embodiment 1 of the present disclosure;

FIG. 8 is a schematic view of a relative permeability curve according to Embodiment 1 of the present disclosure; and

FIG. 9 is a structural view of a system for predicting a relative permeability curve based on machine learning according to Embodiment 2 of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a method and system for predicting a relative permeability curve based on machine learning, so as to improve the accuracy of prediction on the relative permeability curve, and reduce the cost and workload.

To make the above-mentioned objective, features, and advantages of the present disclosure clearer and more comprehensible, the present disclosure will be further described in detail below in conjunction with the accompanying drawings and specific embodiments.

### Embodiment 1

After decades of exploitation, main mature oilfields in China have successively entered a late period of the high water-cut stage or even an ultra-high water-cut stage. The remaining oil in ground is “highly scattered in the whole field and relatively abundant in some localities”. Due to sophisticated fluid distribution in the reservoir stratum, it is increasingly difficult to stabilize oil by controlling water. In combination with geological, seismic, logging and sophisticated numerical simulation technologies, a porous media model is constructed according to the actual reservoir stratum to simulate a seepage process of fluid in the porous media and describe distribution of the remaining oil, which is the basic and crucial part to tap the potentials of high water-cut oilfields and improve the recovery factor in waterflooding.

With the capability of comprehensively reflecting a flowing law of the fluid in the porous media, relative permeabilities are crucial to parameter design of oilfield development, numerical simulation of reservoirs, remaining oil evaluation on the reservoir stratum, level division of the water-flooded layer, and dynamic analysis and research of the oilfield. In conventional numerical simulation, an average oil-water relative permeability curve of one section is often used, or the area is divided according to characteristics of the fluid to obtain multiple average oil-water relative permeability curves. As the actual reservoir is constantly scoured by flooded water, the reservoir stratum changes greatly in microstructure, the heterogeneity of the reservoir is increasingly severe, and seepage characteristics in different areas vary a lot. Consequently, it is hard to use one or more average oil-water relative permeability curves to simulate seepage characteristics of the actual reservoir with the large area and strong heterogeneity, or to accurately describe the distribution of the remaining oil. This is also the reason that makes current numerical simulation results different from recognitions on the oilfield. Therefore, typical, accurate and reliable relative permeability data are fundamental to formulate reasonable and effective development schemes.

At present, there are mainly three common methods to determine the relative permeability curve of the reservoir stratum, namely a laboratory core test method, an empirical equation method and an oilfield development data estimation method. The core test method can obtain a reliable relative permeability curve. However, the measurement of the relative permeability curve with a reservoir core in the laboratory is time-consuming and not cost-effective, and requires professional staffs and equipment, further causing insufficient samples to research the seepage relation in the oilfield development area, and restricting the modeling accuracy in reservoir exploitation. In case of no relative permeability data from the laboratory, the empirical equation method is often used to estimate the relative permeability. Despite the success in a special reservoir, the empirical equation method has the defects of low accuracy and large error, particularly for carbonate reservoir rock. The third method aims to estimate the relative permeability with oilfield development data. However, this method can only obtain the average oil-water relative permeability curve of one reservoir, rather than oil-water relative permeability data of each stratum.

Hence, there have been rare methods for predicting the relative permeability curve. Moreover, the existing methods have certain limitations, and particularly they cannot accurately describe seepage characteristics of oil and water phases in the ultra-high water-cut stage.

In response to rapid development of AI such as deep learning, concepts and methods with which we analyze data, reveal natural laws and predict future trends have been changing profoundly. The AI also provides new opportunities for the innovation and development of petroleum geophysical exploration theories, methods and technologies. Many researches have been carried out by domestic and foreign scholars to predict the relative permeability curve with the AI, and some results have been achieved. On the whole, the researches are still in infancy, with an urgent need for resources and manpower.

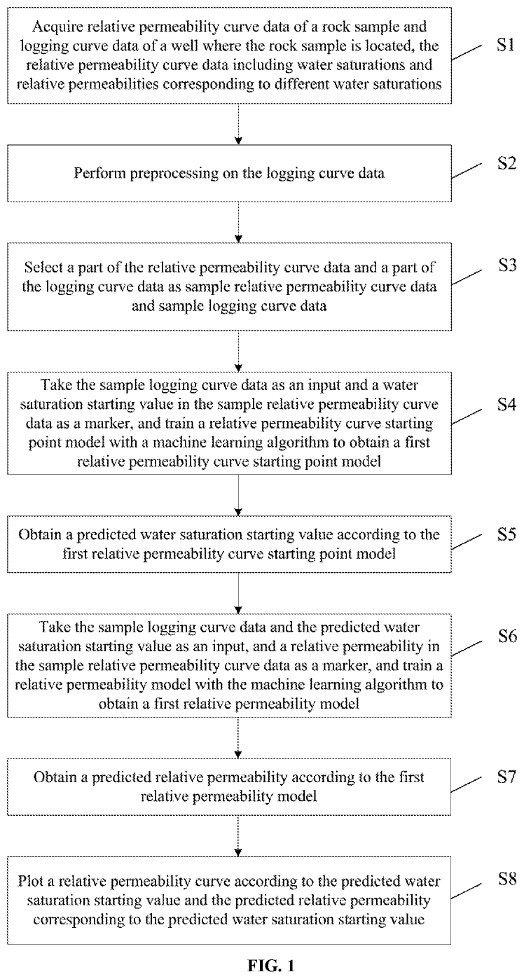

In view of problems in the prior art, as shown in FIG. 1, the embodiment takes the AI algorithm as a tool, and provides a method for predicting a relative permeability curve based on machine learning. The method includes the following steps:

S1: Relative permeability curve data of a rock sample and logging curve data of a well where the rock sample is located are acquired, the relative permeability curve data including water saturations and relative permeabilities corresponding to different water saturations. The relative permeability includes an oil relative permeability and a water relative permeability. The logging curve data include one or more of a gamma-ray (GR), a depth, a diameter, a spontaneous potential (SP), a time difference, a neutron, an acoustic (AC), a shallow resistivity, a gradient resistivity, an induction conductivity (COND) and a density (DEN).

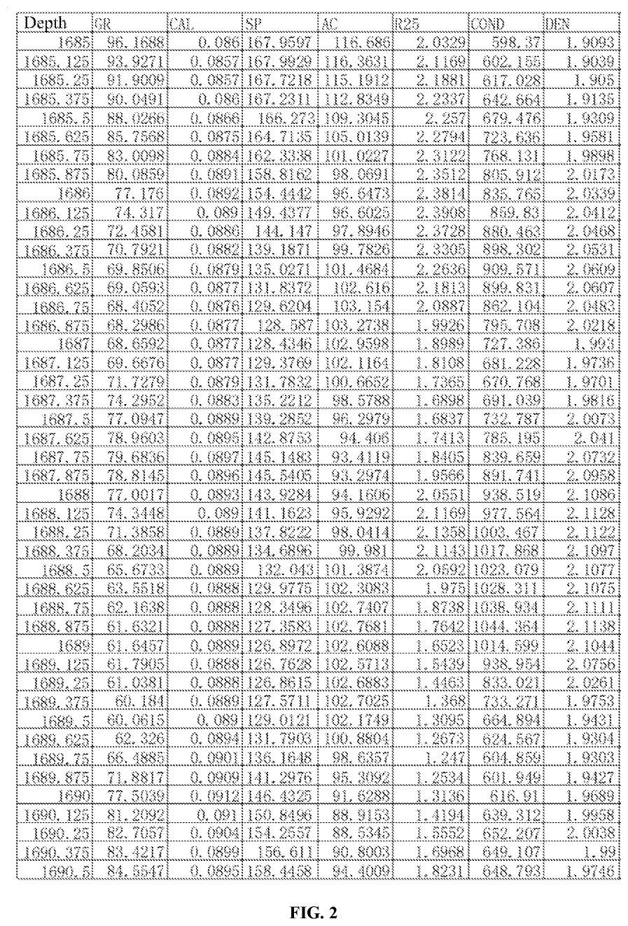

In the embodiment, in view of integrity of the logging curve, seven logging curves including a GR logging curve, a caliper (CAL) logging curve, an SP logging curve, an AC logging curve, 2.5-m gradient apparent resistivity logging (R25) curve, an induction COND logging curve and a DEN logging curve are selected, and a part of data are shown in FIG. 2. The embodiment can be implemented with other types of logging curves different from the examples, different numbers of logging curves, or a combination of different logging curves, and is not limited to the examples herein.

S2: Preprocessing is performed on the logging curve data to obtain processed logging curve data, and the processed logging curve data are taken as new logging curve data. The preprocessing includes marker layer arrangement, correction and complementation.

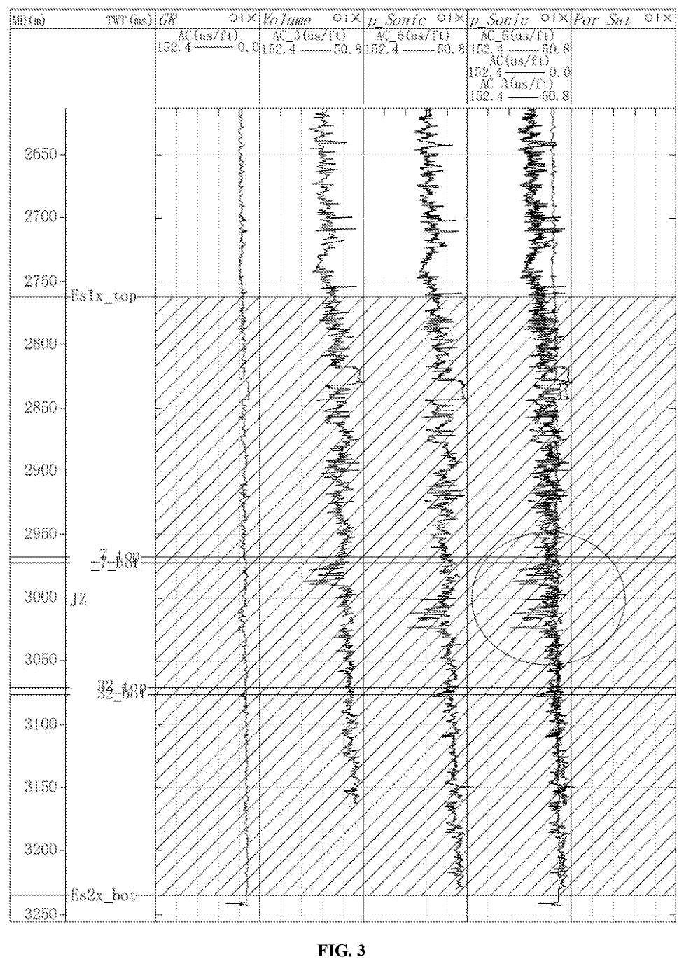

Original logging curve data measured at the oilfield are disordered and thus are screened artificially. As shown in FIG. 3, multiple logging curves are typologically the same, the logging curve data are different in depth, logging values fall into different ranges, and some logging curves are missing, with insufficient logging depths, abnormal logging and so on.

In the embodiment, the logging curves are sorted, and a marker layer is selected reasonably, thereby obtaining first logging curve data.

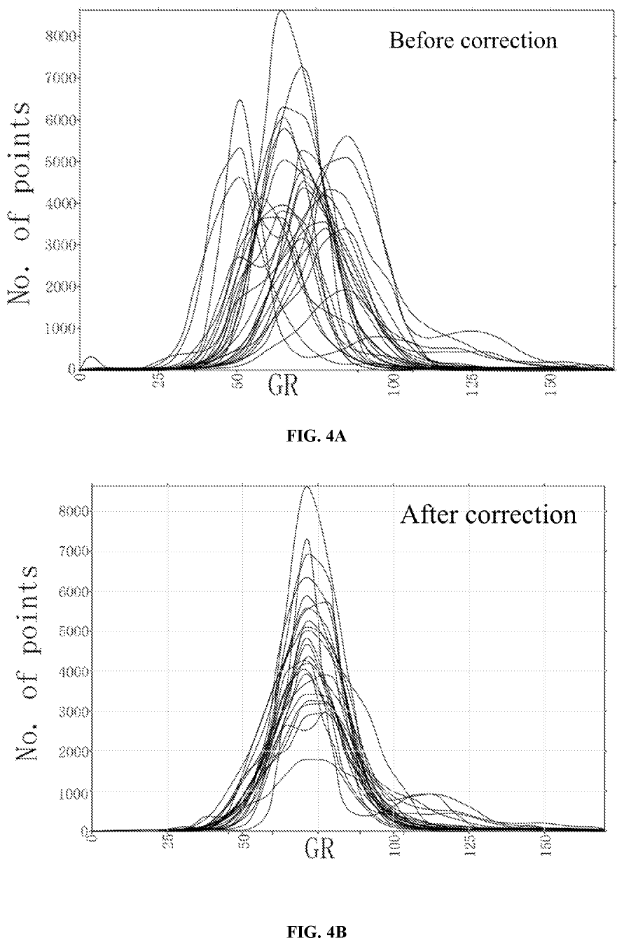

Consistency correction is performed on the first logging curve data with a plotting tool such as a histogram and a crossplot to obtain second logging curve data. As shown in FIG. 4, with consistency correction of the GR logging curve as an example, FIG. 4A is a schematic view before consistency correction on a GR logging curve, and FIG. 4B is a schematic view after consistency correction on a GR logging curve.

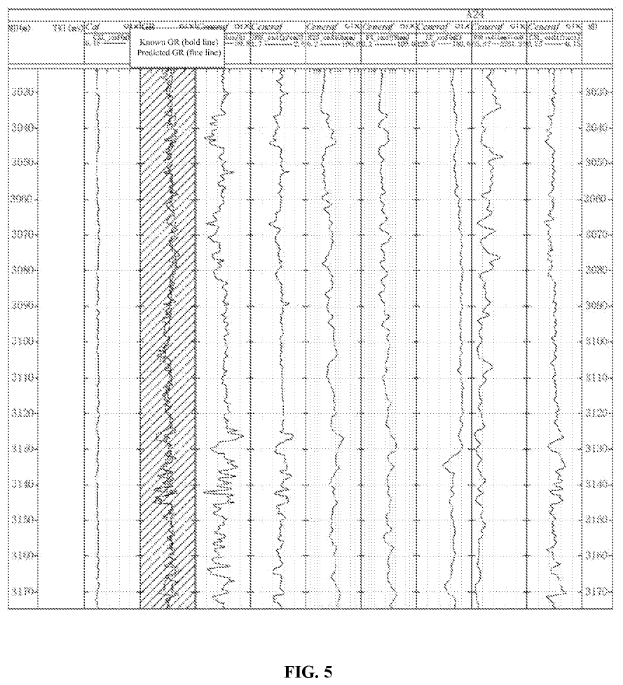

An optimal logging curve is screened from the second logging curve data according to the known sample logging data with an empirical equation, a rock physical model and a deep learning method, thereby complementing the missing logging curve. As shown in FIG. 5, with complementation of the GR logging curve as an example, a GR logging curve to be complemented is predicted according to remaining logging curves. A complete segment on the logging curve is selected to verify the complementation effect.

S3: A part of the relative permeability curve data and a part of the logging curve data are selected as sample relative permeability curve data and sample logging curve data.

268 rock samples from 30 wells are selected to measure relative permeability curves. The rock samples correspond to the wells, and depths at which the rock samples are taken correspond to depths of the wells. A water saturation starting value in the relative permeability curve data of the rock sample serves as a characteristic endpoint value of the relative permeability curve. The database of the rock sample includes two parts, namely a combination of water saturation endpoint values of the logging curve and the relative permeability curve, and a combination of a water saturation starting endpoint value of a predicted relative permeability curve, and data (including the water saturation, oil relative permeability, and water relative permeability) of the logging curve and the relative permeability curve, and the specific application is as follows:

S4: The sample logging curve data are taken as an input and a water saturation starting value in the sample relative permeability curve data is taken as a marker, and a relative permeability curve starting point model is trained with a machine learning algorithm to obtain a first relative permeability curve starting point model.

S5: A predicted water saturation starting value is obtained according to the first relative permeability curve starting point model.

S6: The sample logging curve data and the predicted water saturation starting value are taken as an input, a relative permeability in the sample relative permeability curve data is taken as a marker, and a relative permeability model is trained with the machine learning algorithm to obtain a first relative permeability model.

S7: A predicted relative permeability is obtained according to the first relative permeability model.

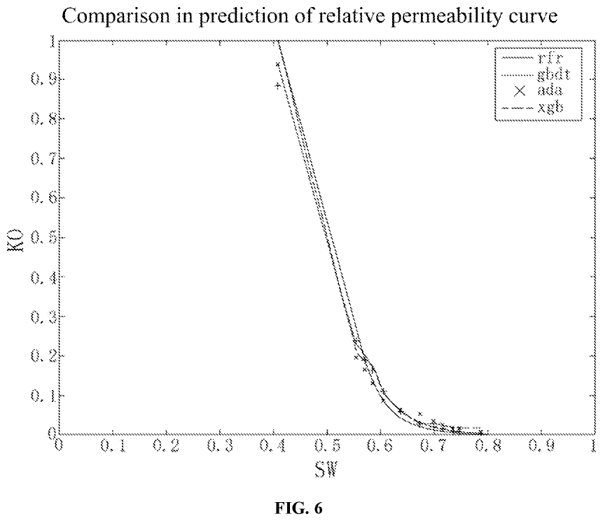

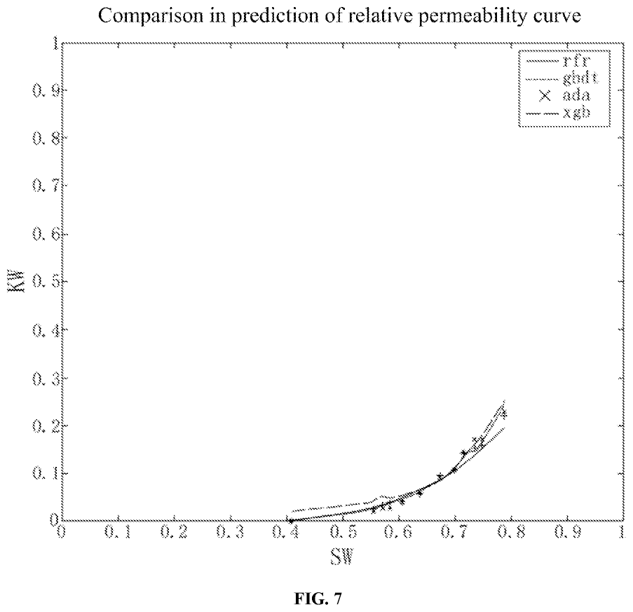

S8: A relative permeability curve is plotted according to the predicted water saturation starting value and the predicted relative permeability corresponding to the predicted water saturation starting value. FIG. 6 illustrates a predicted result of an oil relative permeability curve, and FIG. 7 illustrates a predicted result of a water relative permeability curve. Both predicted results are desirable.

As an optional implementation, the machine learning algorithm includes a random forest (RF), an adaptive boosting (AdaBoost), a gradient boosted decision tree (GBDT) and an extreme gradient boosting (XGBoost).

In order to further improve the accuracy of prediction, the first relative permeability curve starting point model and the first relative permeability model are tested. The first relative permeability curve starting point model is tested specifically as follows:

Remaining relative permeability curve data and remaining logging curve data except the sample relative permeability curve data and the sample logging curve data are respectively selected as test relative permeability curve data and test logging curve data.

The test logging curve data are input to the first relative permeability curve starting point model to obtain a predicted water saturation starting value.

A loss function is established with a mean square error (MSE) according to the predicted water saturation starting value and a water saturation starting value in the test relative permeability curve data.

The first relative permeability curve starting point model is trained completely in case of a minimum of the loss function to obtain a well-trained relative permeability curve starting point model.

The well-trained relative permeability curve starting point model is taken as a new first relative permeability curve starting point model, and the step of “obtaining a predicted water saturation starting value according to the first relative permeability curve starting point model” is returned.

Likewise, the first relative permeability model is tested in a same method, specifically including:

Remaining relative permeability curve data and remaining logging curve data except the sample relative permeability curve data and the sample logging curve data are respectively selected as test relative permeability curve data and test logging curve data.

The test logging curve data and the predicted water saturation starting value are input to the first relative permeability model to obtain a predicted relative permeability.

A loss function is established with an MSE according to the predicted relative permeability and a relative permeability in the test relative permeability curve data.

The first relative permeability model is trained completely in case of a minimum of the loss function to obtain a well-trained relative permeability model.

The well-trained relative permeability model is taken as a new first relative permeability model, and the step of “obtaining a predicted relative permeability according to the first relative permeability model” is returned.

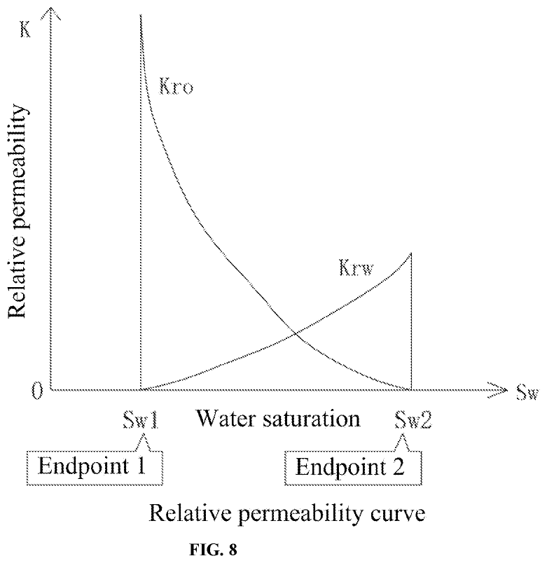

In the embodiment, the water saturation endpoint value on the relative permeability curve is predicted with the XGBoost. 80% of data are used as training data, and 20% of data are used as test data. FIG. 8 illustrates a schematic view of a relative permeability curve. In the figure, the horizontal coordinate of the left endpoint on the curve is Sw1, and the horizontal coordinate of the right endpoint is Sw2. Sw1 and Sw2 are the output of the data. Two endpoint values of the relative permeability curve are predicted at the same by multi-output regression of the XGBoost. The prediction error of Sw1 is 0.65%, and that of Sw2 is 0.21%.

The logging data are combined with the water saturation of the relative permeability curve to take as training data of the first relative permeability model. The machine learning algorithm is taken as a model. A weight of the network is optimized by iteration to minimize the error between the predicted value and the actual value. The loss function established with the MSE is expressed as:

$$MSE = \frac{1}{N} {\sum }_{t = 1}^{N} {( {observed}_{t} - {predicted}_{t} )}^{2}$$

Table 1 shows MSE results of oil-water relative permeability curve predicted by logging data:

TABLE 1

| MSE of predicted result | RF | Adaboost | GBDT | XGBoost |
|---|---|---|---|---|
| Oil relative permeability | 0.98% | 0.83% | 0.75% | 0.56% |
| Water relative permeability | 0.21% | 0.16% | 0.15% | 0.07% |

In the embodiment, a relative permeability curve prediction model based on machine learning is constructed under theoretical guidance of well logging, deposition, reservoir physics, and so on. Two water saturation endpoint values on the relative permeability curve are predicted. The endpoint values are evenly divided as required and combined with logging data to take as input data for predicting relative permeabilities, and then the relative permeabilities are predicted. A relative permeability curve is plotted according to water saturations and corresponding relative permeabilities. Therefore, highly accurate relative permeability data are obtained at a low cost.

According to previous researches, the relative permeability curve is mainly affected by the pore size, temperature, and saturation of the reservoir stratum. In fact, there are many factors to affect prediction of the relative permeability curve. The embodiment provides a new concept for predicting the relative permeability curve by directly using the logging curve based on the machine learning, without establishing a mathematical relative permeability model or simulating a nonlinear control mechanism, which greatly improves the efficiency and accuracy.

### Embodiment 2

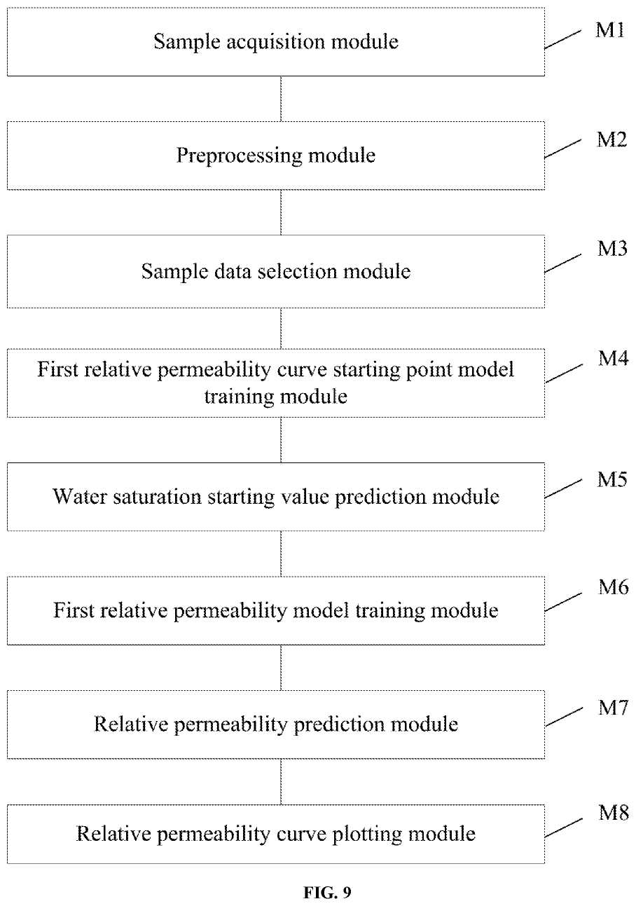

Referring to FIG. 9, the embodiment further provides a system for predicting a relative permeability curve based on machine learning, including:

a sample acquisition module M1 configured to acquire relative permeability curve data of a rock sample and logging curve data of a well where the rock sample is located, the relative permeability curve data including water saturations and relative permeabilities corresponding to different water saturations;

a preprocessing module M2 configured to perform preprocessing on the logging curve data to obtain processed logging curve data, and take the processed logging curve data as new logging curve data, the preprocessing including marker layer arrangement, correction and complementation;

a sample data selection module M3 configured to select a part of the relative permeability curve data and a part of the logging curve data as sample relative permeability curve data and sample logging curve data;

a first relative permeability curve starting point model training module M4 configured to take the sample logging curve data as an input and a water saturation starting value in the sample relative permeability curve data as a marker, and train a relative permeability curve starting point model with a machine learning algorithm to obtain a first relative permeability curve starting point model;

a water saturation starting value prediction module M5 configured to obtain a predicted water saturation starting value according to the first relative permeability curve starting point model;

a first relative permeability model training module M6 configured to take the sample logging curve data and the predicted water saturation starting value as an input, and a relative permeability in the sample relative permeability curve data as a marker, and train a relative permeability model with the machine learning algorithm to obtain a first relative permeability model;

a relative permeability prediction module M7 configured to obtain a predicted relative permeability according to the first relative permeability model; and

a relative permeability curve plotting module M8 configured to plot a relative permeability curve according to the predicted water saturation starting value and the predicted relative permeability corresponding to the predicted water saturation starting value.

In an optional implementation, the system further includes a starting point model test module.

The starting point model test module is configured to test the first relative permeability curve starting point model. The starting point model test module specifically includes:

a test data selection unit configured to respectively select remaining relative permeability curve data and remaining logging curve data except the sample relative permeability curve data and the sample logging curve data as test relative permeability curve data and test logging curve data;

a starting value prediction unit configured to input the test logging curve data to the first relative permeability curve starting point model to obtain a predicted water saturation starting value;

a loss function establishment unit configured to establish a loss function with an MSE according to the predicted water saturation starting value and a water saturation starting value in the test relative permeability curve data; and

a test unit configured to train the first relative permeability curve starting point model completely in case of a minimum of the loss function to obtain a well-trained relative permeability curve starting point model; and take the well-trained relative permeability curve starting point model as a new first relative permeability curve starting point model, and return to the step of “obtaining a predicted water saturation starting value according to the first relative permeability curve starting point model”.

Each embodiment of the present specification is described in a progressive manner, each example focuses on the difference from other examples, and the same and similar parts between the examples may refer to each other. Since the system disclosed in an embodiment corresponds to the method disclosed in another embodiment, the description is relatively simple, and reference can be made to the method description.

Specific examples are used herein to explain the principles and embodiments of the present disclosure. The foregoing description of the embodiments is merely intended to help understand the method of the present disclosure and its core ideas; besides, various modifications may be made by those of ordinary skill in the art to specific embodiments and the scope of application in accordance with the ideas of the present disclosure. In conclusion, the content of the present specification shall not be construed as limitations to the present disclosure.

What is claimed is:

1. A method for predicting a relative permeability curve based on machine learning, comprising:
acquiring relative permeability curve data of a rock sample and logging curve data of a well where the rock sample is located, the relative permeability curve data comprising water saturations and relative permeabilities corresponding to different water saturations;
selecting a part of the relative permeability curve data and a part of the logging curve data as sample relative permeability curve data and sample logging curve data;
taking the sample logging curve data as an input and a water saturation starting value in the sample relative permeability curve data as a marker, and training a relative permeability curve starting point model with a machine learning algorithm to obtain a first relative permeability curve starting point model;
obtaining a predicted water saturation starting value according to the first relative permeability curve starting point model;
taking the sample logging curve data and the predicted water saturation starting value as an input, and a relative permeability in the sample relative permeability curve data as a marker, and training a relative permeability model with the machine learning algorithm to obtain a first relative permeability model;
obtaining a predicted relative permeability according to the first relative permeability model; and
plotting a relative permeability curve according to the predicted water saturation starting value and the predicted relative permeability corresponding to the predicted water saturation starting value.

2. The method for predicting a relative permeability curve based on machine learning according to claim 1, wherein the logging curve data comprise one or more of a gamma-ray (GR), a depth, a diameter, a spontaneous potential (SP), a time difference, a neutron, an acoustic (AC), a shallow resistivity, a gradient resistivity, an induction conductivity (COND) and a density (DEN).

3. The method for predicting a relative permeability curve based on machine learning according to claim 1, after the acquiring relative permeability curve data of a rock sample and logging curve data of a well where the rock sample is located, further comprising: performing preprocessing on the logging curve data; and taking processed logging curve data as new logging curve data.

4. The method for predicting a relative permeability curve based on machine learning according to claim 3, wherein the performing preprocessing on the logging curve data specifically comprises:
selecting a marker layer for the logging curve data to obtain first logging curve data;
performing consistency correction on the first logging curve data with a plotting tool to obtain second logging curve data;
screening an optimal logging curve from the second logging curve data with an empirical equation, a rock physical model and a deep learning method; and
complementing other second logging curve data according to the optimal logging curve.

5. The method for predicting a relative permeability curve based on machine learning according to claim 1, after the obtaining a first relative permeability curve starting point model, further comprising:
testing the first relative permeability curve starting point model, specifically comprising:
respectively selecting remaining relative permeability curve data and remaining logging curve data except the sample relative permeability curve data and the sample logging curve data as test relative permeability curve data and test logging curve data;
inputting the test logging curve data to the first relative permeability curve starting point model to obtain a predicted water saturation starting value;
establishing a loss function with a mean square error (MSE) according to the predicted water saturation starting value and a water saturation starting value in the test relative permeability curve data;
training the first relative permeability curve starting point model completely in case of a minimum of the loss function to obtain a well-trained relative permeability curve starting point model; and
taking the well-trained relative permeability curve starting point model as a new first relative permeability curve starting point model, and returning to the step of “obtaining a predicted water saturation starting value according to the first relative permeability curve starting point model”.

6. The method for predicting a relative permeability curve based on machine learning according to claim 1, after the obtaining a first relative permeability model, further comprising:
testing the first relative permeability model, specifically comprising:
respectively selecting remaining relative permeability curve data and remaining logging curve data except the sample relative permeability curve data and the sample logging curve data as test relative permeability curve data and test logging curve data;
inputting the test logging curve data and the predicted water saturation starting value to the first relative permeability model to obtain a predicted relative permeability;
establishing a loss function with an MSE according to the predicted relative permeability and a relative permeability in the test relative permeability curve data;
training the first relative permeability model completely in case of a minimum of the loss function to obtain a well-trained relative permeability model; and
taking the well-trained relative permeability model as a new first relative permeability model, and returning to the step of “obtaining a predicted relative permeability according to the first relative permeability model”.

7. The method for predicting a relative permeability curve based on machine learning according to claim 1, wherein the machine learning algorithm comprises a random forest (RF), an adaptive boosting (AdaBoost), a gradient boosted decision tree (GBDT) and an extreme gradient boosting (XGBoost).

8. A system for predicting a relative permeability curve based on machine learning, comprising:
a sample acquisition module configured to acquire relative permeability curve data of a rock sample and logging curve data of a well where the rock sample is located, the relative permeability curve data comprising water saturations and relative permeabilities corresponding to different water saturations;
a sample data selection module configured to select a part of the relative permeability curve data and a part of the logging curve data as sample relative permeability curve data and sample logging curve data;
a first relative permeability curve starting point model training module configured to take the sample logging curve data as an input and a water saturation starting value in the sample relative permeability curve data as a marker, and train a relative permeability curve starting point model with a machine learning algorithm to obtain a first relative permeability curve starting point model;
a water saturation starting value prediction module configured to obtain a predicted water saturation starting value according to the first relative permeability curve starting point model;
a first relative permeability model training module configured to take the sample logging curve data and the predicted water saturation starting value as an input, and a relative permeability in the sample relative permeability curve data as a marker, and train a relative permeability model with the machine learning algorithm to obtain a first relative permeability model;
a relative permeability prediction module configured to obtain a predicted relative permeability according to the first relative permeability model; and
a relative permeability curve plotting module configured to plot a relative permeability curve according to the predicted water saturation starting value and the predicted relative permeability corresponding to the predicted water saturation starting value.

9. The system for predicting a relative permeability curve based on machine learning according to claim 8, further comprising: a preprocessing module configured to perform preprocessing on the logging curve data to obtain processed logging curve data, and take the processed logging curve data as new logging curve data, the preprocessing comprising marker layer arrangement, correction and complementation.

10. The system for predicting a relative permeability curve based on machine learning according to claim 8, further comprising a starting point model test module, wherein
the starting point model test module is configured to test the first relative permeability curve starting point model; and the starting point model test module specifically comprises:
a test data selection unit configured to respectively select remaining relative permeability curve data and remaining logging curve data except the sample relative permeability curve data and the sample logging curve data as test relative permeability curve data and test logging curve data;
a starting value prediction unit configured to input the test logging curve data to the first relative permeability curve starting point model to obtain a predicted water saturation starting value;
a loss function establishment unit configured to establish a loss function with a mean square error (MSE) according to the predicted water saturation starting value and a water saturation starting value in the test relative permeability curve data; and
a test unit configured to train the first relative permeability curve starting point model completely in case of a minimum of the loss function to obtain a well-trained relative permeability curve starting point model; and take the well-trained relative permeability curve starting point model as a new first relative permeability curve starting point model, and return to the step of “obtaining a predicted water saturation starting value according to the first relative permeability curve starting point model”.
